(19) United States
(12) Patent Application Publication
(10) Pub. No.: US 2019/0263174 A1
(43) Pub. Date: Aug. 29, 2019

(54) TOOL FOR IMPRINTING A RAISED PATTERN ON A COATING, IMPRINTING KIT AND CORRESPONDING IMPRINTING METHOD

(71) Applicant: SAINT-GOBAIN WEBER, SERVON (FR)

(72) Inventors: Anne DEVORET, PARIS (FR); Camille CLAUDE, PARIS (FR); Stéphanie BALESTE, PONCIN (FR); Céline GUERET, PARIS (FR)

(21) Appl. No.: 16/331,021

(22) PCT Filed: Sep. 7, 2017
(86) PCT No.: PCT/FR2017/052369

§ 371 Date: Mar. 6, 2019

(30) Foreign Application Priority Data
Sep. 8, 2016 (FR) 1658357

(51) Int. Cl. B44C 1/24; B44B 11/04; E01C 19/43; E04F 21/04

(52) U.S. Cl. CPC B44C 1/24; E04F 21/04; E01C 19/43; B44B 11/04

(57) ABSTRACT

A tool intended for imprinting a texture on a coating, in particular a coating applied to a wall, a floor or a ceiling, including a mat having a front face including a working surface with a texture intended to come into contact with the coating, and a holding system. The working surface has a general curvature in at least a first rocking direction, and the holding system comprises at least one first holding zone and one second holding zone spaced in said first rocking direction, whereby the tool can be rocked on the coating by application of a varying force to the first and second holding zones.

### TECHNICAL FIELD

The present invention concerns a tool intended for imprinting a texture on a coating. This imprinting is also known as matting a coating, in particular a coating applied to a wall, a floor or a ceiling. The present invention also concerns a method of imprinting a texture on a coating using a tool of this kind.

### BACKGROUND OF THE INVENTION

It is known to deposit a coating layer on a wall or a floor to be coated. Applied to a façade of a building, the coating generally has a decorative and impermeability function. Applied to an inside wall, its function is primarily decorative. There exist different types of coatings depending on the binder that they comprise. A coating can contain an organic binder, for example an acrylic resin (organic coating) or a mineral binder, for example cement, plaster and/or lime (mineral coating).

To improve the esthetic appearance of the coating, it is known to apply to the as yet not hardened coating a mat having a texture generally comprising decorative patterns.

Patent application FR 2 777 829 describes a method in which a mat with decorative patterns is applied to a green coating layer for between a few minutes and a few hours before being removed. The mat can take the form of a thin rigid or semi-rigid plastic film having a high weight per square meter. In this case the decorative patterns are produced on the film by thermoforming or embossing. These patterns can be imitations of planks of wood, weaving, bricks, tiles, stones, paving, leaves, earth, etc. The plastic film is applied to the coating with the aid of a brush or a trowel, so as to imprint the patterns therein.

According to another embodiment, the mat comprises a roller provided with a texture applied to the coating layer with a PE film type plastic film between them in order to prevent the coating sticking to the roller. The roller can where appropriate be replaced by a parallelepipedal plate.

To imprint a texture on the coating using the aforementioned methods, three operatives must work simultaneously. Two operatives must hold the plastic film or sheet in contact with the coating, while a third operative applies the brush, the roller or the plate to said film or sheet in order to imprint the patterns on the coating. These methods of working take time and are of low productivity for the user because they are labor intensive. Application of the roller or of the plate directly to the coating is not desirable either in that it leads to the formation of undulations on the surface of the coating because of the variation of the pressure exerted by the user, and often even to pulling off of the coating when the mat is removed.

Patent application WO 03/006260 attempts to remedy the above disadvantages by proposing a tool that it is easy to use for a single worker and that does not cause any undulations in or pulling off of the coating. Here the tool comprises a mat including projecting or recessed patterns formed by or fixed to an endless tape tensioned between at least two end rollers in contact with its interior face. The tool takes the form of a caterpillar track having a plane bearing part that is brought into contact with the coating, for example while it is setting, to drive the rotation of the endless belt.

This tool has three major disadvantages. Firstly it is of complex design and complicated to manufacture, and is therefore not very economical. Moreover, the tool does not effectively prevent undulations and marks on the surface of the coating, since the force applied by the user to drive the rotation of the endless belt necessarily varies. Finally, traces of coating can easily jam the rollers, then making use of the tool impossible.

### OBJECT AND SUMMARY OF THE INVENTION

One of the objectives of the present invention is to provide a tool for imprinting a texture on a coating that is easy to manufacture, easy for a single operative to use, and moreover prevents the problems of pulling off and undulations in the coating.

This objective is achieved with the tool intended for imprinting a texture on a coating, in particular a coating applied to a wall, a floor or a ceiling, including:
a mat having a front face including a working surface with a texture intended to come into contact with the coating, and
holding means,
   characterized in that said working surface has a general curvature in at least a first rocking direction, and in that the holding means comprise at least one first holding zone and one second holding zone spaced in said first rocking direction, whereby the tool can be rocked on the coating by application of a varying force to the first and second holding zones.

The tool according to the invention can be used on walls, floors or ceilings.

Where walls are concerned, it is particularly (but not in a limiting manner) suitable for use:
on a coating applied to a façade of a building (new build or refurbishment),
on a coating applied to an external thermal insulating composite system (ETICS) on a building,
on a decorative and/or functional coating (for example with acoustic properties) applied to an internal wall of a building.

The tool according to the invention enables a visible and homogenous texture to be imprinted whatever application force is exerted by the user and its position on the surface.

The movement of rocking the tool moreover enables defects in a previously smoothed coating to be corrected.

The tool is ergonomic, and very easy for a single person to use. It enables rapid matting.

The holding means of the tool according to the invention comprise two spaced holding zones so that an operative can hold the tool with both hands, without external assistance, and then press the working surface of the tool onto the coating to imprint the texture therein.

The holding means of the tool will generally be formed on the rear face of the mat, opposite the front face including the working surface.

The holding zones can in particular be formed by handles, for example handles attached to the rear face of the mat or formed by spaces provided in the body of the mat. According to one example, the holding means comprise two handles, each forming a holding zone.

The holding zones are not necessarily formed by separate handles. They can also be constituted of two spaced parts of the same handle-forming assembly, for example fixed to the rear face of the mat, in particular an element of toroidal general shape that the user could hold like a steering wheel, or a bar extending in the rocking direction.

To enable a firm hold and good control by the user of the pressure exerted on the tool, the first and second holding zones are generally a distance between 200 and 700 mm inclusive apart.

The mat of the tool according to the invention takes the general form of a plate, of which there can be defined a general plane and a transverse direction corresponding to its general direction of application against the coating to be matted.

The mat has a front face and a rear face that together delimit the mat in this transverse direction.

In the present application, by working surface is meant the part of the front face of the mat carrying the texture. According to one example, the working surface extends over at least 80%, preferably over at least 95%, of the front face of the mat. The working surface can also cover the front face of the mat entirely.

For the tool to remain easy for the operative to handle, the front face of the mat advantageously has a total surface area between 0.1 and 1.5 m² inclusive. Here by total surface area is meant the surface area of the envelope surface of the front face. This total surface area is therefore independent of the texture.

The mat can have (in its general plane) a rectangular, round or oval shape or any other appropriate shape. The largest dimension of the mat (diameter or length, in this general plane) is typically between 100 and 1500 mm inclusive, preferably between 300 and 900 mm.

For example, when the mat has a rectangular general shape, its sides preferably have a length and a width each of which is between 100 and 1500 mm inclusive, preferably between 300 and 900 mm.

According to one example, the ratio of the length to the width does not exceed 3.

According to the invention, the working surface has a general curvature in at least one rocking direction.

This general curvature is preferably present over the entire working surface.

In the sense of the present invention, the general curvature of the working surface must be understood as the curvature of the envelope surface of said working surface. The curvature is oriented toward the front, i.e. in the direction of application of the mat to the coating. In other words, the envelope surface of the working surface is convex.

The working surface advantageously has, in the first rocking direction, over at least a central part, a general radius of curvature between 500 and 5000 mm inclusive, preferably between 750 and 3000 mm. Inter alia, this radius of curvature is sufficiently small to allow good circulation of air between the coating and the mat, preventing suction effects that could lead to the coating coming unstuck.

The central part, over which the working surface has a general curvature as defined above, advantageously represents at least 50%, more preferably at least 80% of the surface area of the working surface.

The general curvature of the working surface enables the user to apply the tool to the coating with a rocking movement. This movement enables the bearing pressure to be increased for the same force exerted by the user. It also enables a better distribution of the force exerted on the coating. The rocking movement therefore enables prevention of undulations on the coating. It moreover enables prevention of pulling it off when removing the tool.

According to one advantageous example, the working surface further has a general curvature in a second rocking direction orthogonal to the first rocking direction. In this case, without lifting the mat off the coating, the operative can rock the tool in one direction and then in the other.

In this case, the general radius of curvature of the working surface in the second rocking direction is, over at least the central part referred to above, preferably less than the general radius of curvature of the central part in the first rocking direction.

According to one example, in order to prevent the appearance of demarcation lines at the edges of the treatment zones, the front face of the mat can have a central part and, outside said central part, a fillet—in other words a border having a general radius of curvature less than that of the central part (hereinafter border). Thanks to these dispositions, no clear mark caused by the edges of the tool is imprinted on the coating. The fillet enables progressively decreasing contact between the mat and the coating.

The front face of the mat can have a border of this kind in one direction only or in its two principal directions.

A border will preferably be provided at least in the direction orthogonal to the first rocking direction.

More preferably, a border extends continuously over all the periphery of the front face.

The general radius of curvature of the fillet is advantageously generally between 25 and 450 mm inclusive, preferably between 50 and 250 mm.

The radius of curvature of the border nevertheless need not be identical on the various edges of the mat.

The radius of curvature on the border in the first rocking direction is therefore preferably greater than the radius of curvature of the border in the direction orthogonal to this first direction.

The width of the border is for example between 30 and 150 mm inclusive, and can be identical or not on the various edges of the mat.

The working surface preferably extends over the whole of the central part and over a part of the border, at least in the first rocking direction.

In accordance with a preferred disposition of the invention, the texture is a random texture. The random texture is preferably a texture capable of being superimposed on itself without visible joins and without destroying its legibility. In other words, the texture can be imprinted over a first treatment zone Z1 using the mat, then over a second treatment zone Z2 partly overlapping the zone Z1, without any join being visible at the edges of the zone of superimposition of Z1 and Z2, i.e. without the zone of superimposition being distinguishable visibly from the zones of non-superimposition.

According to one example, the texture extends in a continuous manner over the whole of the working surface.

According to one example, the texture is constituted of unitary elements repeated in a random manner. The unitary elements can in particular interpenetrate.

For the remainder of the present application, the profile is defined as the profile of the texture resulting from the intersection of the front face of the mat and a plane parallel to the transverse direction of the mat.

An element of the profile is defined as a projection of the profile and an adjacent recess of the profile.

The height of a profile element is defined as the height measured between the highest point of the element of the profile and its lowest point.

The width of a profile element is defined as the distance between the two extreme points of the profile element positioned on the median line of the profile.

The average height of the elements of the texture is defined as the arithmetic mean of the absolute values of the heights of the profile elements over a base length of 10 centimeters, calculated independently of the general curvature of the front face.

The average width of the elements of the texture is defined as the arithmetic mean of the absolute values of the widths of the profile elements over a base length of 10 centimeters, calculated independently of the general curvature of the front face.

According to one example, the average height of the elements of the texture is between 0.5 and 50 mm inclusive, preferably between 1 and 20 mm inclusive.

According to one example, the average width of the elements of the texture is between 1 and 100 mm inclusive.

According to one example, the mat can include a skin having a convex external face forming its front face and a concave internal face, and means for stiffening said skin situated on said concave internal face. The stiffening means enable prevention of deformation of the mat between the two holding zones, and ensure a good distribution of the force of the user over the whole of the surface to be matted.

According to one example, the stiffening means comprise reinforcing ribs, in particular ribs forming a honeycomb construction. In this case, the skin and the ribs are advantageously in one piece (i.e. form a single block with no interface within the material).

According to another example, the stiffening means comprise a structure mounted on the skin to tension it so that it can no longer be deformed. The structure can for example be clipped onto the skin. It can for example take the form of a rigid metal, plastic or composite material plate. It can where applicable integrate the holding zones.

According to another example, the mat can include a substrate or core, in particular a solid core, optionally reinforced by an internal armature, and a skin covering said core, the skin having a convex external face forming the front face of the mat.

For example, the skin can take the form of a film, in particular a film of polyethylene (PE), polypropylene (PP), polyethylene terephthalate (PET), polyethylene terephthalate glycol (PETG), or any other thermoformable plastics. The patterns can be formed on the film by thermoforming or by molding. The core can then be formed by a reinforcing lining that lines the concave internal surface of the skin, for example a lining cast or sprayed onto the internal surface of the skin. It is for example of heat-set foam, in particular polyurethane foam. The skin and the reinforcing lining are fastened together, for example stuck together.

According to another example, the core of the mat can be produced for example by molding in a counterform mold corresponding to the required texture, after which a skin-forming layer, in particular a silicone layer, can be deposited onto the face of the core carrying the texture.

According to a further example, the mat is formed of a core or substrate onto which the skin can be fixed in a removable manner. The skin is advantageously interchangeable. In other words, the substrate is adapted to cooperate with skins having different textures, enabling different imprinted renditions.

According to further examples, the mat can be a monolithic block a front face of which includes the working surface with the texture, or a hollow block, formed for example by gas-assisted injection molding.

The mat can generally be produced by all 3D printing processes, by digital milling, by molding, in particular by injection molding, by stratification or by embossing.

The invention also concerns a kit for imprinting a texture on a coating, in particular a coating applied to a wall, a floor or a ceiling, comprising an imprinting tool as defined above as principal tool and a complementary accessory including a mat having a front face with a surface area less than or equal to half the surface area of the front face of the principal tool and having an identical texture, said mat also having a general curvature and at least one holding zone.

The complementary accessory for imprint joins is smaller, enabling its use in areas where access is difficult, for example behind scaffolding poles.

Because of these limited dimensions, the complementary accessory often necessitates only one holding zone.

The front face of the accessory advantageously has a total surface area between 0.01 and 0.12 m² inclusive, preferably between 0.01 and 0.08 m².

The shape of the accessory, likewise the characteristics of its texture, are identical to those described above with reference to the principal tool, and are therefore not described again.

The invention further concerns a method of imprinting a texture on a coating, in particular a coating applied to a wall, a floor or a ceiling, by means of a tool as defined above, characterized in that it includes at least the following step:
a) the tool is applied to a first treatment zone of the coating and rocked in at least one first rocking direction so as to imprint said texture on said first treatment zone.

In practice, the rocking direction of the tool is for example horizontal, vertical and/or diagonal. The operative can easily choose the position that suits them best.

According to one embodiment, the step a) is repeated over a plurality of treatment zones of the coating, so as in particular to produce a continuous texture over the whole of the surface of the coating.

According to one embodiment, the treatment zones are partly superimposed.

According to one embodiment, the method further comprises a step of spraying sand onto the coating, before the step a). Adding sand to the surface of the coating enables prevention of adhesion of the mat and therefore easy lifting off. There can where appropriate be added to the sprayed sand pigments or fragments of glass or any other decorative and/or functional powder solution.

According to one embodiment, the method comprises the application of a water repellent to the coating, before the step a). The water repellent is usually applied to the coating after it has been smoothed. It enables on the one hand easy lifting off of the mat and on the other half better ageing of the coating, already improved by the matting itself.

According to one embodiment, the method further comprises the application of an algicide and/or fungicide product to the coating, before the step a).

According to one embodiment, the method further comprises the application of a mold release product to the front face of the tool and/or to the surface of the coating to be matted, before the step a).

The invention finally concerns a substrate chosen from a wall, a floor or a ceiling of a building, coated with a textured coating layer, in particular obtained by the imprinting method as defined above, in which the texture is formed by a plurality of partly superimposed identical base textures without superimposition zones being visually distinguishable from non-superimposition zones.

The texture preferably covers the whole of the surface of the substrate.

A plurality of examples or embodiments are described in the present description. However, unless otherwise specified, the features described with reference to any one example or embodiment can be applied to any other example or embodiment.

### BRIEF DESCRIPTION OF THE DRAWINGS

The invention will be better understood and its advantages will become more apparent on reading the following detailed description of a plurality of embodiments shown by way of nonlimiting example. The description refers to the appended drawings, in which:

FIG. 1 is a perspective view of the front face of a tool in accordance with a first embodiment;

FIG. 2 is a perspective view of the rear face of the tool from FIG. 1;

FIG. 3 shows the mat in section on the longitudinal plane III of symmetry in FIG. 1;

FIG. 4 is a view to a larger scale of the detail IV from FIG. 3;

FIG. 5 shows interleaving of different unitary elements of the texture of the working surface;

FIG. 6 shows the mat seen in section on the lateral plane VI of symmetry in FIG. 1;

FIG. 7 shows a mat in accordance with a second embodiment, seen in section on a lateral plane of symmetry;

FIG. 8 shows a variant texture for the working surface of the mat;

FIG. 9 shows a mat in accordance with a third embodiment, in section on a longitudinal plane of symmetry;

FIGS. 10A to 10C show diagrammatically the successive steps of a method of application of the tool according to the invention;

FIG. 11 shows various treatment zones for treating a coating using a tool according to the invention;

FIGS. 12A, 12B and 12C show various techniques for use of the tool according to the invention, which can be combined with one another;

FIG. 13 shows a complementary imprinting accessory that can form part of an imprinting kit according to the invention.

### DETAILED DESCRIPTION OF EMBODIMENTS

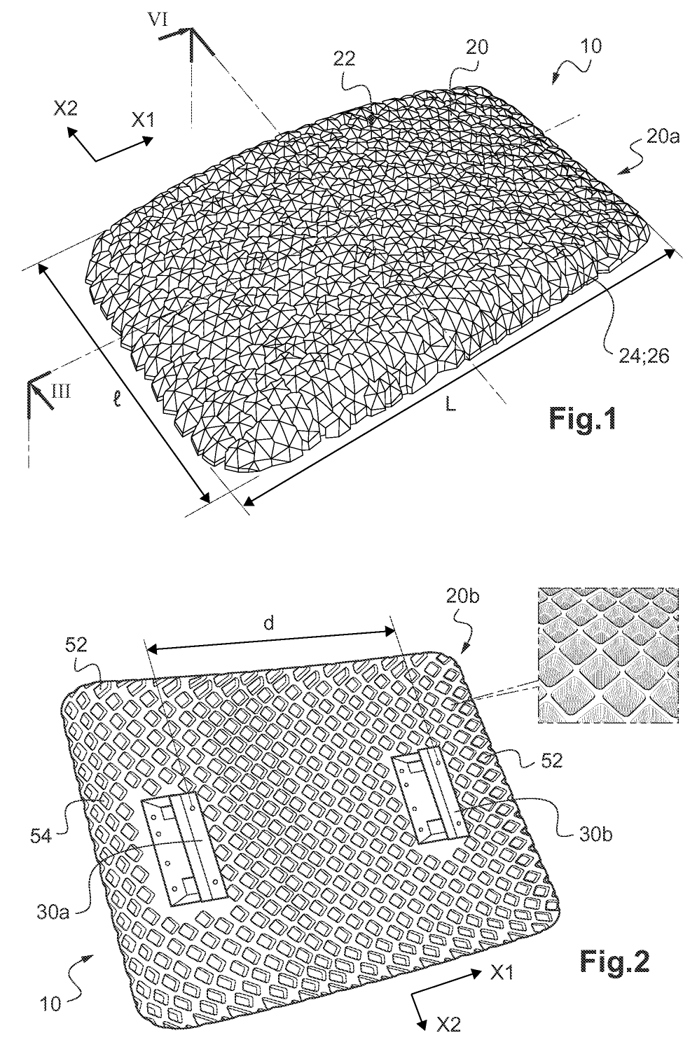

FIGS. 1 to 6 show an imprinting tool 10 in accordance with a first embodiment of the invention.

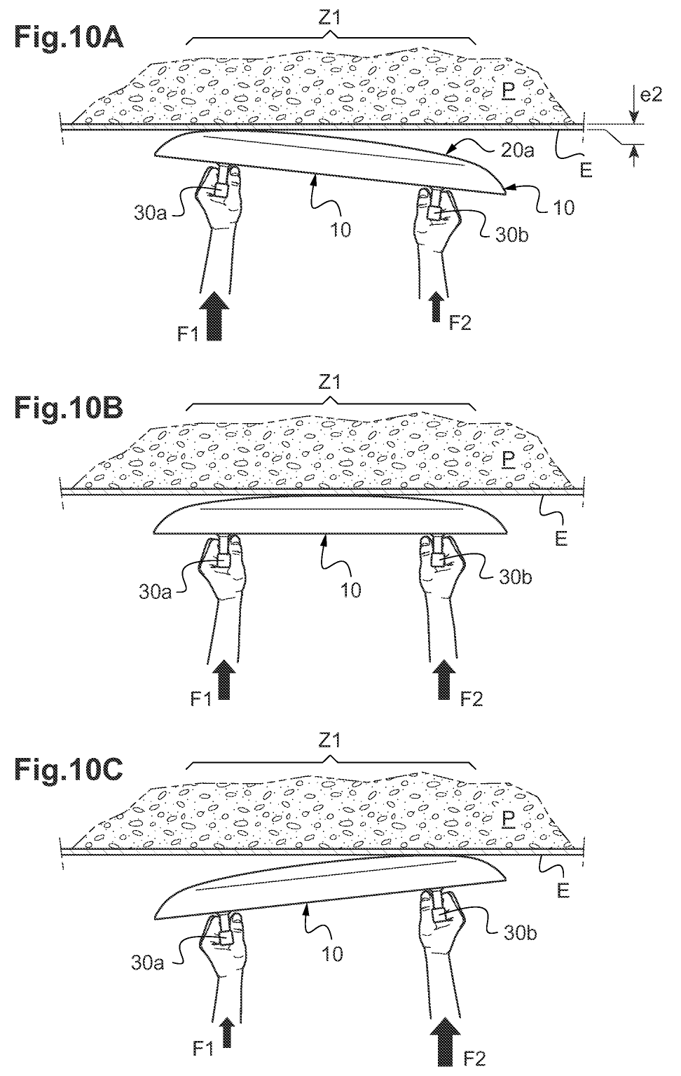

The tool 10 is intended to be applied by a single user against a coating E to be matted, with a rocking movement described in more detail below with reference to FIGS. 10A to 10C.

To that end, here the tool 10 comprises:
a mat 20 having
   a front face 20a shown in more detail in FIG. 1, including a working surface 22 with a texture 24 intended to come into contact with the coating E,
   a rear face 20b opposite the front face 20a and therefore oriented toward the user, shown in more detail in FIG. 2, and
two holding zones, here in the form of two handles 30a, 30b mounted on the rear face 20b of the mat (here by screwing them on, see FIG. 2).

In the example, the mat 20 takes the form of a globally rectangular plate having two longitudinal edges of length L measured in a longitudinal direction X1 and two lateral edges of width I measured in a lateral direction X2 orthogonal to X1. The length L and the width I are typically between 100 and 1500 mm inclusive, preferably between 300 and 900 mm. For ease of handling, the front face 20a of the mat 20 advantageously has a total surface area between 0.1 and 1.5 m² inclusive.

In the example shown in FIG. 2, the two handles 30a, 30b of the tool 10 extend parallel to one another in the lateral direction X2 and are spaced from one another in the longitudinal direction X1. The tool 10 is intended to be held in two hands by the user, each hand holding one of the handles 30a, 30b. The spacing d between the two handles or holding zones 30a, 30b is therefore advantageously chosen to correspond substantially to the average distance between the extended fists of the user manipulating the mat, in line with their shoulders. The spacing d is typically between 200 and 700 mm inclusive.

As indicated above, the tool 10 is intended to be applied to the coating E with a rocking movement. To this end, its front face 20a has a general curvature in at least one rocking direction, corresponding to the direction of spacing of the two holding zones 30a, 30b, here the longitudinal direction X1.

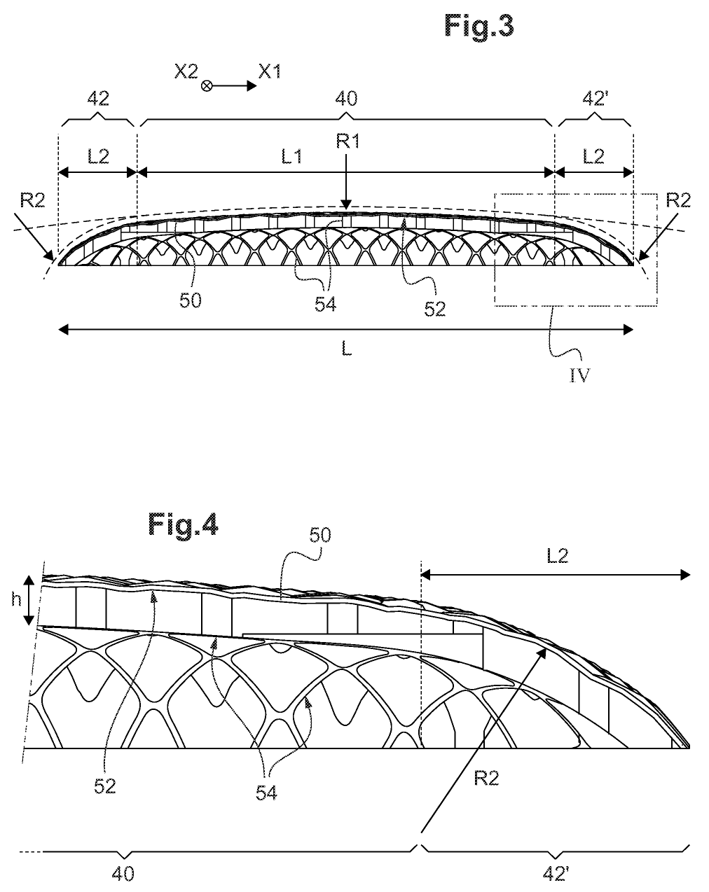

This curvature is shown in more detail in FIG. 3 which shows the mat 20 seen in section on the plane III of symmetry in FIG. 1 (orthogonal to X2).

To be more precise, in the example the front face 20a has a central part 40 intended to come into contact with the coating E and having a general radius of curvature R1. The total surface area of the central part 40 represents at least 80% of the surface area of the front face 20a. Its length L1 measured in the rocking direction is generally equal to at least 80% of the total length L.

The general radius of curvature R1 over the central part 40 must be sufficiently small to allow good circulation of air between the coating and the mat, preventing the suction effects that could lead to the coating coming unstuck, but sufficiently large in any event to facilitate the rocking movement. R1 is typically between 500 and 5000 mm inclusive, preferably between 750 and 3000 mm.

In the FIG. 1 example, the central part 40 is curved only this rocking direction X1. In other words, over the whole of the central part 40, the envelope surface of the front face 20a takes the form of a right cylinder portion of diameter R1. FIG. 6 shows the mat in section on the plane VI in FIG. 1. It is seen that in the direction X2 the central part 40 of the front face 20a has no general curvature.

As shown in more detail in FIG. 4, the front face 20a of the mat 20 has, outside and on either side of the central part 40, a rounded border or fillet 42, 42′ having a general radius of curvature R2 less than that of the central part 40 (R2<R1).

According to one example, the general radius of curvature R2 of the borders 42, 42′ is between 25 and 450 mm inclusive, preferably between 50 and 250 mm. Each border 42, 42′ advantageously forms a continuous peripheral strip along a lateral edge of the mat.

The width L2 of each border is typically between 30 and 150 mm inclusive.

Here the working surface 22 extends over the whole of each border 42, 42′.

During use, these borders or fillets enable prevention of the appearance on the coating surface of clear marks caused by the edges of the tool.

In the example shown, the front face of the mat also has, in the direction X2, orthogonal to the rocking direction X1, outside and on either side of the central part 40, rounded borders 43, 43′ having a general radius of curvature R3 typically between 25 and 450 mm inclusive, preferably between 50 and 250 mm. Each border 43 advantageously forms a continuous peripheral strip along a longitudinal edge of the mat. The radius of curvature R3 can be equal or not to the radius of curvature R2 of the border 42. R3 is generally chosen less than R2.

The width L3 of each border 43, 43′ is typically between 30 and 150 mm inclusive. It can be equal or not to the width L2 of the borders 42.

In the example, as shown in FIG. 1, the working surface 22 with the texture 24 covers the whole of the front face 20a of the mat. In other words, the front face 20a is entirely covered by the texture 24 to be imprinted. In variants, the working surface 22 can also extend over only a part of the front face 20a, generally the greater part of that face 20a, preferably at least 80%, more preferably 95% of that face 20a. In this case, and if the front face has one or more peripheral borders of the type described above, the working surface then advantageously extends over at least part of said borders.

Here the texture 24 is a random and continuous texture formed by the juxtaposition of unitary elements 26. In the particular example from FIGS. 1 to 6, the texture is constituted of a multitude of interpenetrating hexagonal pyramids with the same shapes and dimensions, but possibly with varying orientations about their axis. The tops of the pyramids are oriented toward the outside of the mat. The texture 24 is therefore a so-called “positive” texture.

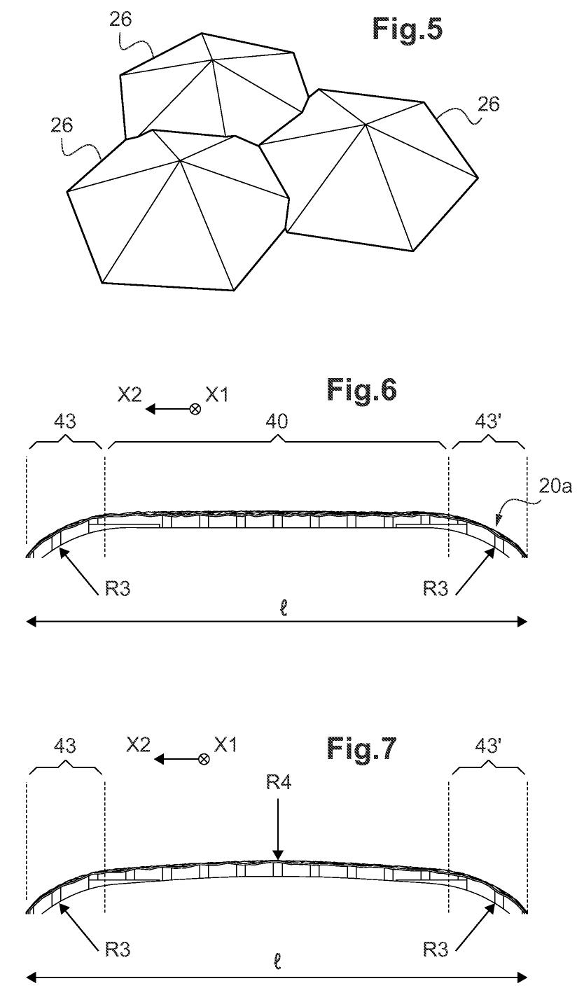

FIG. 5 is a detail view of three pyramids 26 of the texture 24.

The average width of these pyramids is for example between 1 and 100 mm inclusive.

Their average height is for example between 0.5 and 50 mm inclusive, preferably between 1 and 10 mm inclusive.

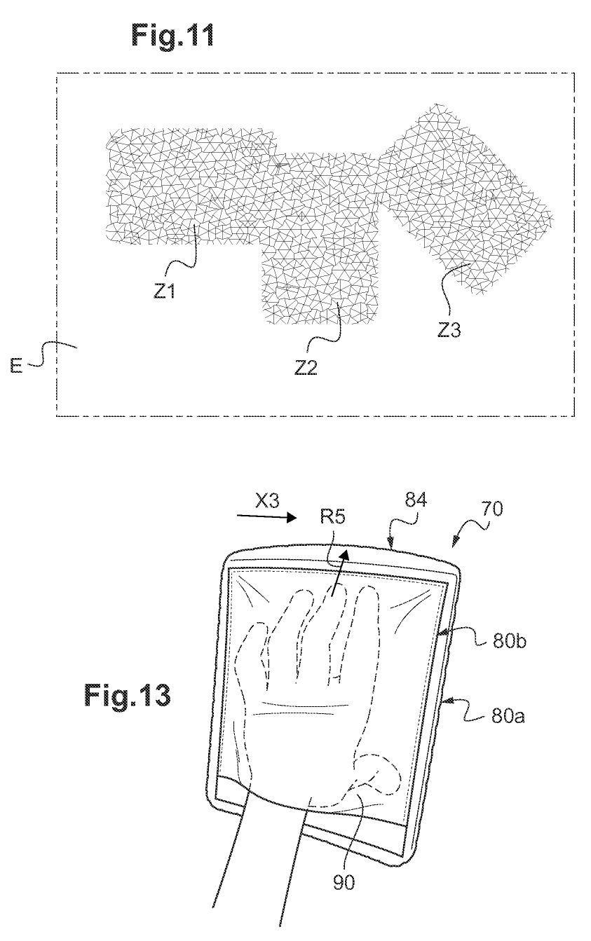

The texture 24 is a random texture, capable of being superimposed on itself with no visible joins and without destroying its legibility. Different partly intersecting coating zones Zi (hereinafter treatment zones) can therefore be imprinted using the tool 10, whilst preserving a very homogenous rendition of the imprinted texture, as will be described below with reference to FIG. 11. The use of markers for positioning the mat 20, a common practice with prior art devices, is therefore not necessary.

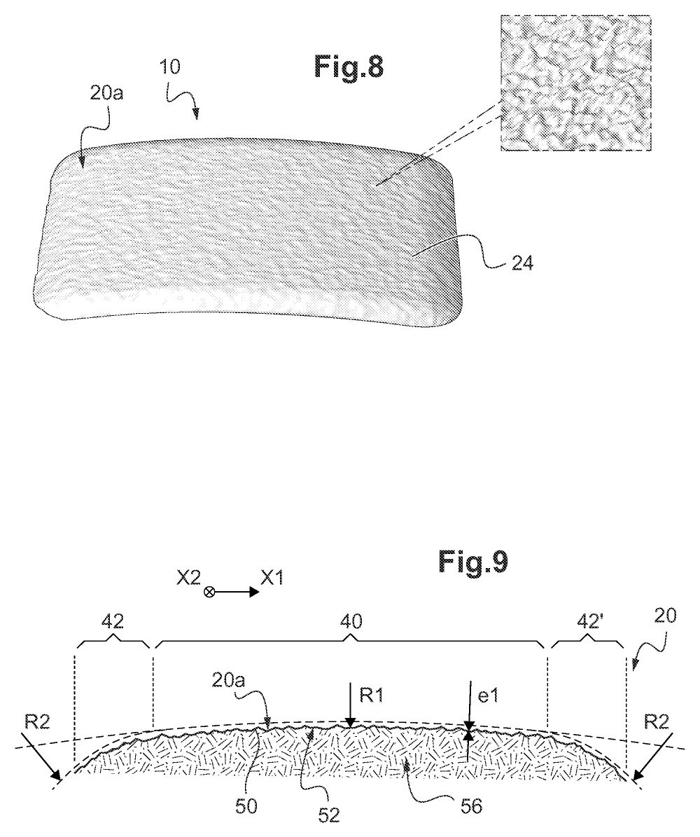

FIG. 8 shows a variant of the texture 24 of the working surface 22. Here the shape of the texture 24 on the working surface 22 has been generated from a visual noise image typically constituted of a random set of black and white points, interpreted by software to generate recesses and bosses respectively corresponding to these black and white points.

According to another variant that is not shown, the shape of the texture 24 can also be generated from an intermediate texture shape obtained from a visible noise image by the method referred to above, said intermediate shape being reworked afterwards by software into a summation of plane surfaces. In this case, the software as it were simplifies the geometry of the texture initially created.

The examples shown in the figures are obviously not of a limiting kind. For example, the texture 24 can also be a negative texture (recessed shapes instead of spikes or bosses). It has nevertheless been found that a “positive” texture, in other words one made up of bosses or spikes and not of recesses, enables a more legible imprint of the texture 24 to be obtained on the coating E. This also contributes to preventing air pockets between the mat 20 and the coating E. The esthetic rendition obtained in this way is particularly clear.

FIG. 7 shows a mat in accordance with a second embodiment of the invention. This mat differs from that of the first embodiment only in that its front face 20a has, in the central part 40, a general curvature not only in the first rocking direction X1 but also in a second rocking direction orthogonal to the first and here corresponding to the lateral direction X2.

The mat in accordance with this second embodiment therefore has a front face that is domed on the outside like a shield.

In the central part, the general radius of curvature R4 in the second rocking direction S2 is generally less than the radius of curvature R1 in the first rocking direction.

Clearly an arrangement of this kind enables rocking of the mat in a first direction and then in a second direction orthogonal to the first, without lifting the mat 20 off the surface of the coating E.

Note that in this case also the radius of curvature R3 of the fillet 43 in the second rocking direction X2 is obviously less than the radius of curvature R4 of the central part 40 in the same direction.

Moreover, the radius of curvature R3 is generally (but not in a limiting way) less than the radius of curvature R2 of the border 42 in the first rocking direction X1.

In the embodiments described above (see in particular FIGS. 3 and 4), the front face 20a of the mat 20 is formed by a skin 50 having a convex external face forming the front face 20a and a concave internal face 52, with means for stiffening the skin 50 on said concave internal face 52, in the form of reinforcing ribs 54, in particular ribs forming a honeycomb structure, advantageously in one piece with the skin. The ribs 54 have for example a height h between 10 and 30 mm inclusive. They enable prevention of deformation of the mat 20 in particular in the zones situated between the two handles 30a, 30b, where the mat is less rigid overall. The mat is for example produced by 3D printing or 3D machining and for example made of acrylonitrile butadiene styrene (ABS), polyamide (PA), polypropylene (PP), or polyethylene terephthalate (PET).

FIG. 9 shows a mat 20 according to a third embodiment of the invention. Here the mat includes a core 56 and a skin 50 covering said core, the skin having a convex external face forming the front face 20a of the mat and concave internal face 52 in contact with the core.

In the example, the skin 50 takes the form of a film, in particular a film of polyethylene (PE), polypropylene (PP), polyethylene terephthalate (PET), polyethylene terephthalate glycol (PETG), or any other thermoformable plastic, for example with thickness e1 between 0.5 and 5 mm inclusive, on which the patterns have been formed by thermoforming or by molding.

The core 56 is formed by a reinforcing lining that lines the concave internal surface 52 of the skin 50, for example a lining cast or sprayed onto the internal surface of the skin. It is for example made of thermoset foam, in particular polyurethane foam. The skin and the reinforcing lining are fastened to one another, for example stuck to one another.

According to another embodiment, not shown, the core of the mat can be produced for example by molding in a counterform mold corresponding to the required texture, after which a layer forming a skin, in particular a layer of silicone or of PTFE (polytetrafluoroethylene) can be deposited on the face of the core carrying the texture.

A layer of silicone or of PTFE is particularly advantageous in that it has non-stick properties enabling the mat to be easily lifted off the coating during imprinting.

The imprinting of a texture on a coating E applied to a wall P using a tool 10 according to the invention will be described in more detail now with reference to FIGS. 10A to 12C.

Matting is generally carried out on a coating E that is still green (i.e. not yet hardened) applied to its substrate with a minimum thickness e2 of approximately 4 to 5 mm.

According to one example of use, before application of the mat 20 and where applicable after being smoothed first, the still green coating E is subjected to spraying of sand and/or application of a water repellant, a mold release agent or any other solutions to prevent the coating sticking to the mat. This pretreatment makes it possible to ensure good lifting off of the mat. In the case of sprayed sand, there may where appropriate be added to said sand pigments, for example and not in a limiting manner colored or photoluminescent pigments, or particles of glass or any other decorative and/or functional powder solutions to enhance or to modify the esthetics of the rendition and/or its functionalities.

An algicide and/or fungicide product can where appropriate be applied to the coating E as well.

Instead of this or in addition to this, a mold release product can also be applied to the front surface 20a of the tool 10.

These pretreatment steps are however not necessary in all cases and must be envisaged in particular as a function of the type of coating to be matted.

As indicated above, the tool 10 is intended to be manipulated in two hands by the user.

FIG. 10A shows the user in position to start imprinting on a first treatment zone Z1.

The matting gesture is initiated, typically leaving a margin of a few centimeters between the edge (here the left-hand edge) of the tool 10 and the surface of the coating E, in order not to mark the edge of the mat 20 on the coating.

Force is applied first to the left-hand handle 30a, as shown by the arrow F1 in FIG. 10A.

The tool 10 is then rocked progressively, here toward the right, as shown in FIG. 10B, progressively reducing the force applied to the left handle and increasing the force applied to the right handle (see corresponding arrow F2 in the figures).

The movement continues until the mat 20 is lifted off the surface of the coating E, but without the right-hand edge of the tool touching said surface.

This movement is then repeated over the whole of the surface of the coating E to be matted.

As shown in FIG. 11, the mat is advantageously applied over partly superimposed treatment zones Zi. The overlap between the different passes of the mat and the random character of the texture ensure the absence of visible joins.

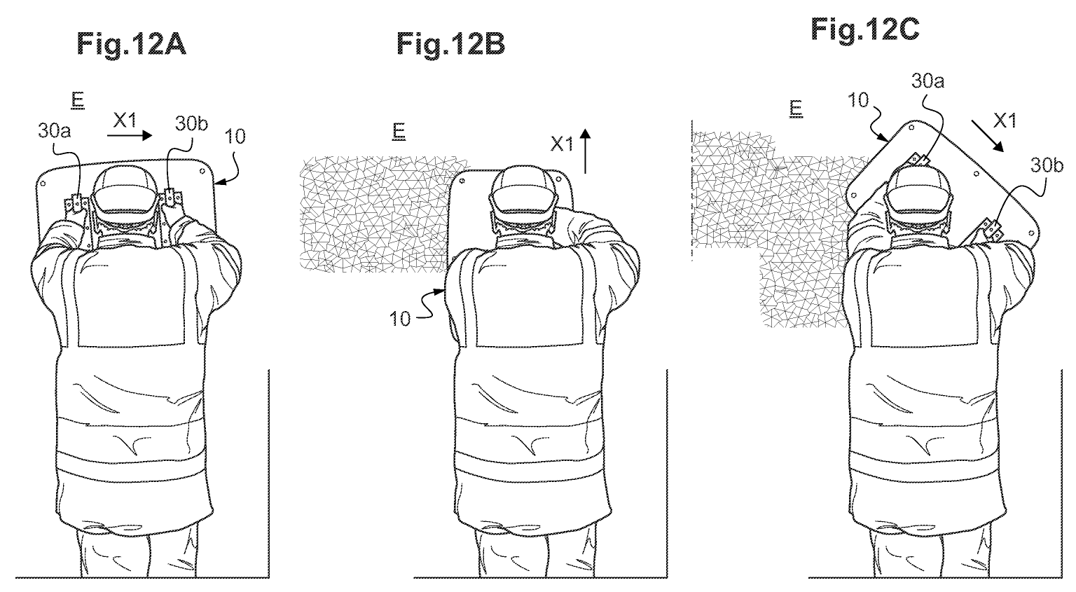

As shown in FIGS. 12A, 12B and 12C, matting can be carried out with any inclination of the mat relative to the horizontal.

The rocking direction can for example be horizontal (FIG. 12A), vertical (FIG. 12B) or oblique (FIG. 12C), and can obviously be varied during use.

In the same way, although rocking from left to right has been described above, it can obviously be carried out from right to left and/or repeated multiple times in the same treatment zone Zi.

Also, in the case of a mat with two rocking directions (of the type shown in FIG. 7), the tool can be rocked from one side to the other and then from top to bottom and/or vice versa.

Some zones of the surface of the coating E to be matted can become difficult to access on site. This is the case for example of zones situated behind scaffolding poles.

To allow the matting of these zones where access is difficult, there can be provision for using a complementary accessory 70 as shown in FIG. 13, in addition to the principal tool 10 as described above. This accessory 70 also includes a mat 80 having a front face 80a with a texture 84 identical to that 24 of the principal tool, and at least one holding zone 90 generally on its rear face 80b. Like the principal tool 10, it has a general curvature R5 in at least one rocking direction X3, so that it can be rocked on the coating E by application of a force from one side and then from the other of said holding zone 90 or alternatively on each holding zone in the case of an accessory having at least two spaced holding zones.

The accessory 70 is smaller than the principal tool 10 described above to enable it to get into tight spaces. The total surface area of the front face 80a of the accessory (i.e. the surface area of the envelope surface of the front face 80a, which is independent of the texture) is therefore less than or equal to half the total surface area of the front face 20a of the principal tool 10, the idea being that the accessory 70 can generally be held and rocked with one hand.

In the example, the accessory 70 is the shape of a rectangular plate, the front face of which has a total surface area between 0.01 and 0.1 m² inclusive, preferably between 0.01 and 0.08 m².

In the example, the holding zone 90 is a pocket fixed to the rear face 80b of the mat 80 and intended to receive the hand of the user like a glove.

This example is not of a limiting nature, however, and the holding zone 90 could also be formed by a handle of any shape mounted on the rear of the mat 80.

The present invention also concerns an imprinting kit comprising a principal tool as shown in FIGS. 1 to 12C and a corresponding complementary accessory as shown in FIG. 13.

1. A tool arranged to imprint a texture on a coating, comprising:
a mat having a front face including a working surface with a texture arranged to come into contact with the coating, and
a holding system,
wherein said working surface has a general curvature in at least a first rocking direction, and the holding system comprises at least one first holding zone and one second holding zone spaced in said first rocking direction, whereby the tool can be rocked on the coating by application of a varying force to the first and second holding zones.

2. The tool as claimed in claim 1, wherein the texture is a random texture.

3. The tool as claimed in claim 1, wherein the texture is constituted of unitary elements repeated in a random manner.

4. The tool as claimed claim 1, wherein an average height of the texture is between 0.5 and 50 mm inclusive.

5. The tool as claimed in claim 1, wherein an average width of the elements of the texture is between 1 and 100 mm inclusive.

6. The tool as claimed in claim 1, wherein the working surface extends over at least 80% of the front face of the mat.

7. The tool as claimed in claim 1, wherein the working surface has, in said first rocking direction, over at least a central part, a general radius of curvature between 500 and 5000 mm inclusive.

8. The tool as claimed in claim 1, wherein the front face of the mat has a total surface area between 0.1 and 1.5 m² inclusive.

9. The tool as claimed in claim 1, wherein the mat has a rectangular general shape the sides of which have a length and a width between 100 and 1500 mm inclusive.

10. The tool as claimed in claim 1, wherein the front face of the mat has a central part and, outside said central part, a border having a general radius of curvature less than that of the central part.

11. The tool as claimed in claim 10, wherein the working surface extends over the whole of the central part and over a part of said border, at least in the first rocking direction.

12. The tool as claimed in claim 1, wherein the working surface further has a general curvature in a second rocking direction orthogonal to the first rocking direction.

13. The tool as claimed in claim 1, wherein the holding system comprises two handles, each forming a holding zone.

14. The tool as claimed in claim 1, wherein the two holding zones are spaced from one another by a distance between 200 and 700 mm inclusive.

15. A kit for imprinting a texture on a coating, comprising an imprinting tool as claimed in claim 1 as principal tool and a complementary accessory including a mat having a front face with a total surface area less than or equal to half the total surface area of the front face of the principal tool and having an identical texture, said mat also having a general curvature and at least one holding zone.

16. A method of imprinting a texture on a coating using a tool as claimed in claim 1, comprising:
a) applying the tool to a first treatment zone of the coating and rocking the tool in at least one first rocking direction so as to improve said texture on said first treatment zone.

17. The imprinting method as claimed in claim 16, wherein step a) is repeated over a plurality of treatment zones of the coating.

18. The imprinting method as claimed in claim 17, wherein the treatment zones are partly superimposed.

19. A substrate chosen from a wall, a floor or a ceiling of a building, coated with a coating layer having a texture, obtained by the imprinting method as claimed in claim 16, wherein the texture is formed by a plurality of partly superimposed identical base textures without superimposition zones being visually distinguishable from non-superimposition zones.

20. The tool as claimed in claim 1, wherein the coating is to be applied to a wall, a floor or a ceiling.

21. The tool as claimed claim 4, wherein the average height of the texture is between 1 and 20 mm inclusive.

22. The tool as claimed in claim 6, wherein the working surface extends over at least 95% of the front face of the mat.

23. The tool as claimed in claim 7, wherein the working surface has, in said first rocking direction, over at least a central part, a general radius of curvature between 750 and 3000 mm.

24. The tool as claimed in claim 9, wherein the length and the width are between 300 and 900 mm.

25. The kit as claimed in claim 15, wherein the coating is to be applied to a wall, a floor or a ceiling.

26. The method as claimed in claim 16, wherein the coating is to be applied to a wall, a floor or a ceiling.
